(19) United States
(12) Patent Application Publication
(10) Pub. No.: US 2006/0215755 A1
(43) Pub. Date: Sep. 28, 2006

(54) Video encoding methods and systems for battery-powered apparatus

(75) Inventor: Chi-Cheng Ju, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/089,306

(22) Filed: Mar. 24, 2005

(51) Int. Cl. H04N 7/12; H04N 11/04; H04B 1/66; H04N 11/02

(52) U.S. Cl. 375/240.12

(57) ABSTRACT

Video encoding methods for battery-powered apparatus are provided. The power level of a battery is detected. One picture type/picture size/picture rate among multiple picture types/picture sizes/picture rates is determined contingent upon the power level. The picture is encoded with the determined picture type/picture size/picture rate.

### BACKGROUND

The invention relates to video encoding, and more particularly, to video encoding methods and devices for battery-powered appliances.

Video encoding methods have been evaluated regarding compression efficiency. The objectives of the first video standards were the storage of films on a CD (MEG-1), the broadcast of television programs on cable/satellite (MPEG-2) and the streamming/downloading of video content over the Internet (MPEG-4). The constraints are bandwidth and storage capacity. The evaluation criterion is the computational complexity, especially in applications where real-time encoding is necessary. Typically, compression efficiency is still important, while computational complexity becomes less problematic due to the increasing speed of processors. In new applications, especially in handheld devices, power consumption has become increasingly important. Handheld devices, such as personal digital assistants (PDAs) or mobile phones, are expected to offer video encoding capabilities in the near future.

Typically, the power consumption is either controlled architecturally or algorithmically. For example, the paper entitled “An 80/20 MHz 160 mW multimedia processor integrated with embedded DRAM, MPEG-4 accelerator and 3-D rendering engine for mobile application”, by C. W. Yoon et al., IEEE Journal of Solid-State Circuits, Volume: 36, Issue: 11, pp. 1758-1767, November 2001, describes a low power consumption video device. The device comprises embedded memories that are located near the central processing unit (CPU) and co-processors, such that data access requires less travel through less cable and dissipates less energy. The paper entitled “Motion Estimation for Low Power Video Devices”, by C. De Vleeschouwer, T. Nilsson, in International Conference on Image Processing, 2001., Vol. 2, 2001, pp. 953-956, describes a low power method. In this document, the low power consumption is achieved by reducing memory accesses and transfers.

### SUMMARY

Video encoding methods for battery-powered apparatus are provided. An embodiment of a method comprises detecting the power level of a battery of an apparatus, determining one picture type/size/rate among multiple picture types/sizes/rates contingent upon the battery power level for a picture to be encoded, and encoding the picture with the determined picture type/size/rate.

Video encoding systems capable of encoding video data are provided. An embodiment of a video encoding system comprises a battery, a detection unit and an encoder. The detection unit couples to the battery and detects the power level within the battery. The encoder couples to the detection unit, determines one picture type/size/rate among multiple picture types/sizes/rates contingent upon the detected battery power level for a picture to be encoded, and encodes the picture with the determined picture type/size/rate.

### DESCRIPTION OF THE DRAWINGS

Video encoding systems and methods will become more fully understood by referring to the following detailed description of embodiments with reference to the accompanying drawings, wherein:

FIG. 1 is a diagram showing a structure of an exemplary MPEG-2 video bitstream;

FIG. 2 is a diagram showing picture architecture of an exemplary MPEG-2 video bitstream;

FIG. 3 is a diagram of a hardware environment applicable to an embodiment of a handheld device;

FIG. 4 is a diagram applicable to an embodiment of a video encoder;

FIGS. 5, 6 and 7 are flowcharts showing embodiments of video encoding methods.

### DESCRIPTION

A digital video stream includes a series of static pictures, requiring considerable storage capacity and transmission bandwidth. A 90-min full color video stream, having a resolution of 640×480 pixels/picture rendered at a rate of 15 pictures/sec, requires bandwidth of 640×480 pixels/picture×3 bytes/pixel×15 pictures/sec=13.18 MB/sec and file size of 13.18 MB/sec×90×60=69.50 GB, for example. Such a sizeable digital video stream is difficult to store and transmit in real time, thus, many compression techniques have been introduced.

MPEG standards ensure video encoding systems create standardized files that can be opened and played on any system with a standards-compliant decoder. Digital video contains spatial and temporal redundancies, which may be compressed without significant sacrifice. MPEG encoding is a generic standard, intended to be independent of a specific application, involving compression based on statistical redundancies in temporal and spatial directions. Spatial redundancy is based on the similarity in color values shared by adjacent pixels. MPEG employs intra-picture spatial compression on redundant color values using DCT (Discrete Cosine Transform) and quantization. Temporal redundancy refers to identical temporal motion between video pictures, providing smooth, realistic motion in video. MPEG relies on prediction, more precisely, motion-compensated prediction, for temporal compression between pictures. MPEG utilizes, to create temporal compression, I-pictures (Intra-coded pictures), B-pictures (bidirectionally predictive-pictures) and P-pictures (predictive-coded pictures). I-picture is an intra-coded picture, a single image beading a sequence, with no reference to previous or subsequent pictures. MPEG-1 compresses only within the picture with no reference to previous or subsequent pictures. P-pictures are forward-predicted pictures, encoded with reference to a previous I- or P-picture, with pointers to information in a previous picture. B-pictures are encoded with reference to a previous reference picture, a subsequent reference picture, or both. Motion vectors employed may be forward, backward, or both.

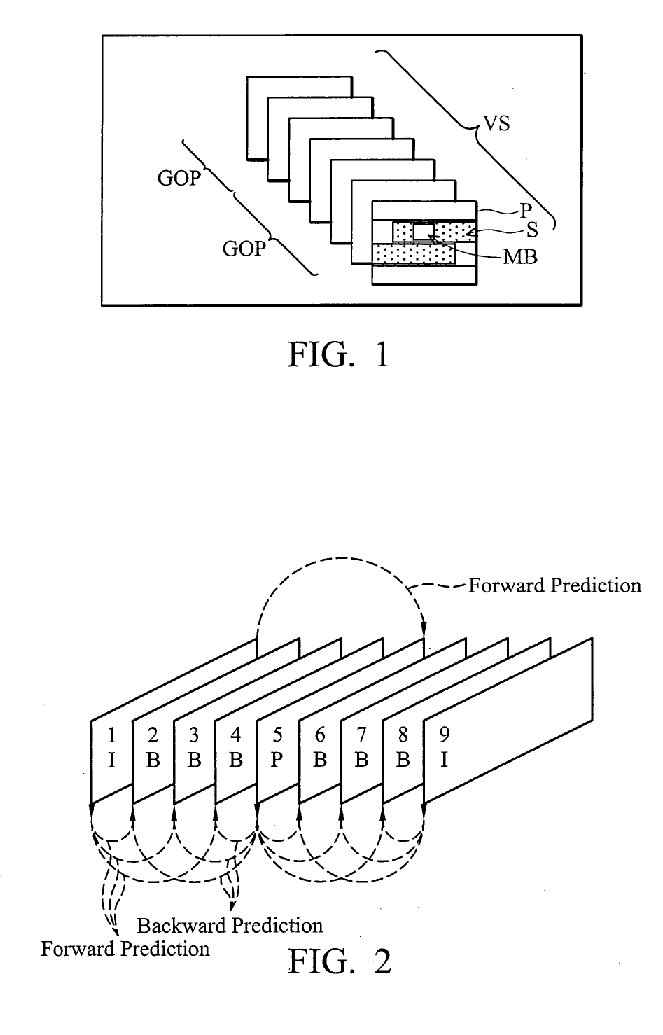

FIG. 1 is a diagram showing a structure of an exemplary MPEG-2 video bitstream. A video stream (VS) is composed of multiple pictures or groups of pictures (GOPs). The picture, a basic unit in compression, includes three types of picture, I-picture, P-picture, and B-picture. Each picture is divided horizontally into fixed lengths to produce multiple slices (Ss) as the minimum unit in signal synchronization and error control. Each S is composed of multiple macroblocks (MBs) at 16×16 pixels is the minimum unit in color sampling, motion estimation and motion compensation. Each MB, composed of four blocks of 8×8 pixels is the minimum unit in DCT.

FIG. 2 is a diagram showing picture architecture of an exemplary MPEG-2 video bitstream. In MPEG-2 video, I-picture has no reference picture, and is compressed by quantization and variable length coding methods, thus, can be treated as an initiation point for decompression without other pictures. The I-picture is the first picture in the VS or GOP, and those following are P-pictures and B-pictures. A P-picture refers to one reference picture, such as an I-picture or prior P-picture, to locate similar MBs. When there is no similar MB, the MBs in the P-picture can be compressed using intra-coding. Basically, P-pictures are composed of both intra-coded MBs and predictive-coded MBs, where the content of the predictive-coded MB is a motion vector and calculated according to the reference picture. The compression rate of P-pictures is normally higher than that of I-pictures because P-pictures are compressed by motion prediction methods based on a reference picture. A B-picture refers to both subsequent and previous reference pictures to locate similar MBs. Like the P-picture, when there is no similar MB, such MBs within the B-picture use intra-coding for compression. The compression rate of B-pictures is normally higher than that of the other two types because B-pictures refer to both subsequent and previous picture to increase likelihood of locating similar MBs in compression using motion estimation methods. B-pictures cannot be further referenced by other pictures.

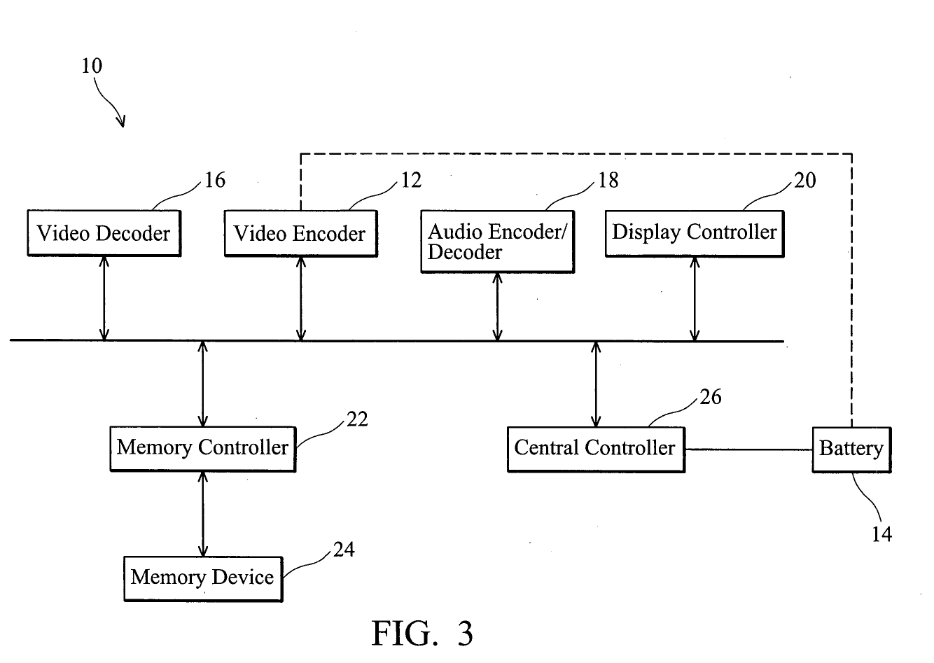

FIG. 3 is a diagram of a hardware environment applicable to an embodiment of a handheld device 10, comprising a video encoder 12, a battery 14, a video decoder 16, an audio encoder/decoder 18, a display controller 20, a memory controller 22, a memory device 24 and a central controller 26. The battery 14 is a main power source or auxiliary power source for the device 10. The memory device 24 is preferably a random access memory (RAM), but may also include read-only memory (ROM) or flash ROM. The memory device 24 temporarily stores data for video encoding. Typically, large temporary data requires more storage capability of memory device 24, leading to greater power consumption of the battery 14. The central controller 26 controls the video decoder 16, video encoder 12, audio encoder/decoder 18, display controller 20 and memory controller 22 to direct video encoding functions. Note that the battery 14 may couple to the central controller 26 rather than to the video encoder 16 for battery level detection, and the video encoder 16 may acquire battery level by querying the central controller 26.

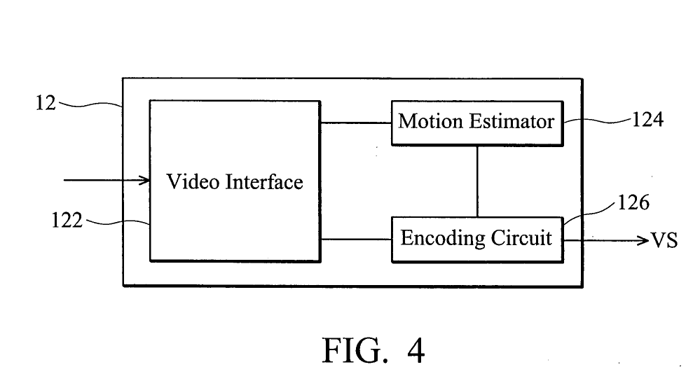

FIG. 4 is a diagram applicable to an embodiment of a video encoder 12, comprising a video interface 122, a motion estimator 124 and encoding circuit 126. The video encoder 12 encodes digitized video data to generate a VS. The motion estimator 124, coupling to the video interface 122, performs various motion estimation methods for MBs in the digitized video data. The encoding circuit 126, coupling to the video interface 122 and motion estimator 124, controls the entire encoding process, encodes estimated pictures using DCT, Quantization, VLC or others, to generate a VS, and generates reference pictures for motion estimation using Inverse Quantization, Inverse DCT (IDCT), Motion Compensation (MC) or others.

Referring to FIG. 3, if the battery 14 is full or near full, the video encoder 12 is adapted to be more power consuming, yielding a better video quality. If the battery 14 is empty or near empty, the video encoder 12 is adapted to be less power consuming in order to provide longer battery life while gradually reducing the quality of the video. On the contrary, if the battery level becomes low, the handheld apparatus will still be able to encode instead of shutting down, but at lower quality.

Generally, encoding a P-picture requires more memory bandwidth than encoding an I-picture, leading to more power consumption, and further encoding a B-picture requires the largest memory bandwidth, leading to the most power consumption. Thus, if the battery 14 is full or near full, the video encoder 12 provides full capacity to encode B-pictures, P-pictures and I-pictures, yielding a good video quality. If the battery is at a medium level, the video encoder 12 precludes B-picture encoding to save power. If the battery 14 is near empty, the video encoder 12 only performs I-picture encoding in order to provide longer lifetime while gradually reducing the quality of the video.

Referring to FIG. 3, an embodiment of the video encoder 12 may receive video data, acquire the power level within the battery 14, determine one picture type among multiple picture types, such as I-, P- and B-pictures, contingent upon the power level, and encodes at least one picture in the video data to generate a VS. In some examples, the video encoder 12 may further select the I- or P-picture type for encoding at least one picture in the video data when the power level is lower than a threshold. In some examples, the video encoder 12 may further select the intra-coded or the predictive-coded picture type for encoding at least one picture in the video data when the power level is lower than a first threshold, and select only the intra-coded picture type for encoding a picture when the power level is further lower than a second threshold, where the second threshold is lower than the first threshold. In some examples, the video encoder 12 may determine a picture size among multiple picture sizes, such as 720×480, 360×240, 180×120 (pixels/picture) and the like, for at least one picture in the video data, contingent upon the power level, and encode the picture further with the determined picture size. In some examples, the video encoder 12 may determine a picture rate among multiple picture rates such as 40, 35, 30, 25, 20, 15, 10 (pictures/sec) and the like, for at least one picture in the video data contingent upon the power level and encode the picture further with the determined picture rate. In some examples, the video encoder 12 may also determine a picture size among multiple picture sizes, and a picture rate among multiple picture rates, for at least one picture in the video data, contingent upon the power level, and encode the picture further with the determined picture size and picture rate.

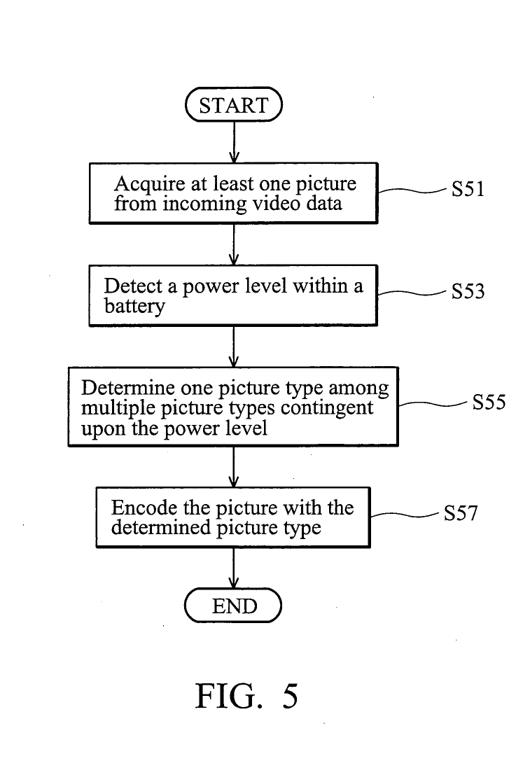

FIG. 5 is a flowchart showing an embodiment of a video encoding method utilized in battery-powered apparatus. In step S51, at least one picture is acquired from incoming video data. In step S53, the power level within the battery of the apparatus is detected. In step S55, one picture type is determined among types of I-, P- and B-pictures contingent upon the power level. In step S57, the picture is encoded with the determined picture type to generate a VS. In some examples, step S55 may further select one between the I- and P-picture types for encoding the acquired picture when the power level is lower than a threshold. In some examples, step S55 may further select one between the I- and P-picture types for encoding the acquired picture when the power level is lower than a first threshold, and select only the I-picture type for encoding the acquired picture when the power level is further lower than a second threshold, where the second threshold is lower than the first threshold. In some examples, step S55 may also determine a picture size among multiple picture sizes, such as 720×480, 360×240, 180×120 (pixels/picture) and the like, for the acquired picture contingent upon the power level, and step S57 may encode the picture further with the determined picture size. In some examples, step S55 may also determine a picture rate among multiple picture rates, such as 40, 35, 30, 25, 20, 15, 10 (pictures/sec) and the like, for the acquired picture contingent upon the power level, and step S57 encodes the picture further with the determined picture rate. In some examples, step S55 may determine a picture size among multiple picture sizes, and a picture rate among multiple picture rates, for the acquired picture contingent upon the power level, and step S57 encodes the picture further with the determined picture size and picture rate.

Referring to FIG. 3, generally, encoding pictures with a larger picture size (i.e. a higher resolution) requires more storage capacity, leading to more power consumption, than with a lower picture size. Thus, if the battery 14 is full or near full, the video encoder 12 provides full capacity to encode pictures in the largest picture size, for example, 720×480 (pixels/picture), yielding a good video quality. If the battery is at a medium level, the video encoder 12 encodes pictures in smaller picture size, for example, 360×240 (pixels/picture), to save power. If the battery 14 is near empty, the video encoder 12 encodes pictures in the smallest picture size, for example, 180×120 (pixels/picture), in order to provide longer battery life while gradually reducing the quality of the video.

An embodiment of the video encoder 12 may receive video data, acquire the power level within the battery 14, determine one picture size among multiple picture sizes contingent upon the power level, and encodes at least one picture in the video data to generate a VS. In some examples, the video encoder 12 may determine a new picture size smaller than a default picture size for encoding a picture when the detected power level is lower than a threshold. In some examples, the video encoder 12 may determine a first picture size smaller than a default picture size for encoding a picture when the detected power level is lower than a first threshold, and determine a second picture size smaller than the first picture size for encoding a picture when the power level is further lower than a second threshold, where the second threshold is lower than the first threshold. In some examples, the video encoder 12 may also determine a picture rate among multiple picture rates for at least one picture in the video data, contingent upon the power level, and encode the picture further with the determined picture rate.

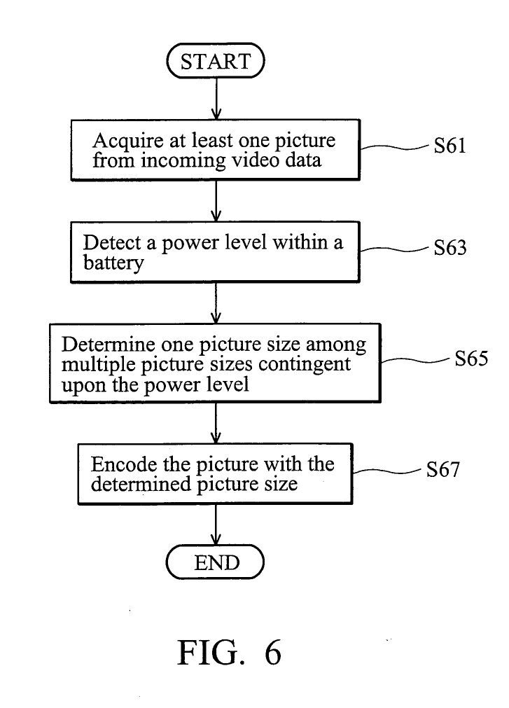

FIG. 6 is a flowchart showing an embodiment of a video encoding method utilized in battery-powered apparatus. In step S61, at least one picture is acquired from incoming video data. In step S63, the power level within the battery of the apparatus is detected. In step S65, one picture size is determined among multiple picture types, such as 720×480, 360×240, 180×120 (pixels/picture) and the like, contingent upon the power level. In step S67, the picture is encoded with the determined picture size to generate a VS. In some examples, step S65 may determine a new picture size smaller than a default picture size for encoding the picture when the detected power level is lower than a threshold. In some examples, step S65 may determine a first picture size smaller than a default picture size for encoding the picture when the detected power level is lower than a first threshold, and determine a second picture size smaller than the first picture size for encoding the picture when the power level is further lower than a second threshold, where the second threshold is lower than the first threshold. In some examples, step S65 may also determine a picture rate among multiple picture rates, such as 40, 35, 30, 25, 20, 15, 10 (pictures/sec) and the like, for the acquired picture contingent upon the power level, and step S67 encodes the picture further with the determined picture rate.

Referring to FIG. 3, generally, encoding pictures at a higher picture rate requires more storage capacity, leading to more power consumption, than at a lower picture rate. Thus, if the battery 14 is full or near full, the video encoder 12 encodes pictures at the highest picture rate, for example, 40 (pictures/sec), yielding a better video quality. If the battery is at a medium level, the video encoder 12 encodes pictures at a medium picture rate, for example, 30 (pictures/sec), to save power. If the battery 14 is near empty, the video encoder 12 encodes pictures at the lowest picture rate, for example, 20 (pictures/sec), in order to provide longer battery life while gradually reducing the quality of the video.

An embodiment of the video encoder 12 may receive video data, acquire the power level within the battery 14, determine one picture rate among multiple picture rates contingent upon the power level, and encodes at least one picture in the video data to generate a VS. In some examples, the video encoder 12 may determine a new picture rate lower than a default picture rate for encoding a picture when the detected power level is lower than a threshold. In some examples, the video encoder 12 may determine a first picture rate lower than a default picture rate for encoding a picture when the detected power level is lower than a first threshold, and determine a second picture size lower than the first picture rate for encoding a picture when the power level is further lower than a second threshold, where the second threshold is lower than the first threshold.

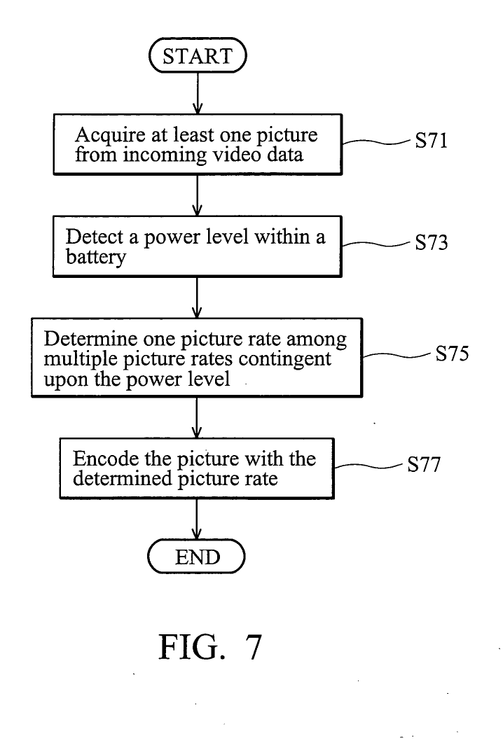

FIG. 7 is a flowchart showing an embodiment of a video encoding method utilized in battery-powered apparatus. In step S71, at least one picture is acquired from incoming video data. In step S73, the power level within the battery of the apparatus is detected. In step S75, one picture rate is determined among multiple picture rates contingent upon the power level. In step S77, the picture is encoded with the determined picture rate to generate a VS. In some examples, step S75 may determine a new picture rate lower than a default picture rate for encoding the picture when the detected power level is lower than a threshold. In some examples, step S75 may determine a first picture rate lower than a default picture rate for encoding the picture when the detected power level is lower than a first threshold, and determine a second picture size lower than the first picture rate for encoding the picture when the power level is further lower than a second threshold, where the second threshold is lower than the first threshold.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

What is claimed is:

1. A video encoding method for battery-powered apparatus, comprising:
detecting a power level within a battery;
determining one picture type among a plurality of picture types contingent upon the power level detected within the battery for a picture to be encoded; and
encoding the picture with the determined picture type.

2. The method of claim 1 wherein the picture types comprise intra-coded, predictive-coded, and bidirectionally predictive-coded pictures.

3. The method of claim 2 wherein determining the one picture type comprises selecting the intra-coded or the predictive-coded picture type for encoding the picture when the detected battery power level is lower than a first threshold.

4. The method of claim 3 wherein determining the one picture type further comprises selecting the intra-coded picture type for encoding the picture when the detected battery power level is further lower than a second threshold.

5. The method of claim 1 further comprising:
determining a picture size for the picture contingent upon the detected battery power level; and
encoding the picture further with the determined picture size.

6. The method of claim 5 further comprising:
determining a picture rate contingent upon the detected battery power level; and
encoding the picture further with the determined picture rate.

7. The method of claim 1 further comprising:
determining a picture rate according to the detected battery power level; and
encoding the picture further with the determined picture rate.

8. A system capable of encoding video data, comprising:
a battery;
a detection unit coupled to the battery and detecting the power level within the battery; and
an encoder coupled to the detection unit, determining one picture type among a plurality of picture types contingent upon the detected battery power level for a picture to be encoded, and encoding the picture with the determined picture type.

9. The device of claim 8 wherein the picture types comprise intra-coded, predictive-coded and bidirectionally predictive-coded pictures.

10. The device of claim 9 wherein the encoder selects the intra-coded or the predictive-coded picture type for encoding the picture when the detected battery power level is lower than a first threshold.

11. The device of claim 10 wherein the encoder selects the intra-coded picture type for encoding the picture when the detected battery power level is further lower than a second threshold.

12. The device of claim 8 wherein the encoder also determines a picture size for the picture contingent upon the detected battery power level and encodes the picture further with the determined picture size.

13. The device of claim 8 wherein the encoder also determines a picture rate contingent upon the detected battery power level and encodes the picture further with the determined picture rate.

14. A video encoding method for battery-powered apparatus, comprising:
detecting the power level within a battery;
determining one picture size among a plurality of picture sizes contingent upon the detected battery power level for a picture to be encoded; and
encoding the picture with the determined picture size.

15. The method of claim 14 further comprising determining a first picture size smaller than a default picture size for encoding the picture when the detected battery power level is lower than a first threshold.

16. The method of claim 15 further comprising determining a second picture size smaller than the first picture size for encoding the picture when the detected battery power level is further lower than a second threshold.

17. The method of claim 14 further comprising:
determining a picture rate contingent upon the detected battery power level; and
encoding the picture further with the determined picture rate.

18. A system capable of encoding video data, comprising:
a battery;
a detection unit coupled to the battery and detecting the power level within the battery; and
an encoder coupled to the detection unit, determining one picture size among a plurality of picture sizes contingent upon the detected battery power level for a picture to be encoded, and encoding the picture with the determined picture size.

19. The system of claim 18 wherein the encoder determines a first picture size smaller than a default picture size for encoding the picture when the detected battery power level is lower than a first threshold.

20. The system of claim 19 wherein the encoder determines a second picture size smaller than the first picture size for encoding the picture when the detected battery power level is further lower than a second threshold.

21. The system of claim 18 wherein the encoder determines a picture rate contingent upon the detected battery power level and encodes the picture further with the determined picture rate.

22. A video encoding method for battery-powered apparatus, comprising:
detecting the power level within a battery;
determining one picture rate among a plurality of picture rates contingent upon the detected battery power level for a picture to be encoded; and
encoding the picture with the determined picture rate.

23. The method of claim 22 further comprising determining a first picture rate lower than a default picture rate for encoding the picture when the detected battery power level is lower than a first threshold.

24. The method of claim 23 further comprising determining a second picture rate lower than the first picture rate for encoding the picture when the detected battery power level is further lower than a second threshold.

25. A system capable of encoding video data, comprising:
a battery;
a detection unit coupled to the battery and detecting the power level within the battery; and
an encoder coupled to the detection unit, determining one picture rate among a plurality of picture rates contingent upon the detected battery power level for a picture to be encoded, and encoding the picture with the determined picture rate.

26. The system of claim 25 wherein the encoder determines a first picture rate lower than a default picture rate for encoding the picture when the detected battery power level is lower than a first threshold.

27. The system of claim 26 wherein the encoder determines a second picture rate lower than the first picture rate for encoding the picture when the detected battery power level is further lower than a second threshold.
